(19) United States
(12) Patent Application Publication
(10) Pub. No.: US 2026/0058969 A1
(43) Pub. Date: Feb. 26, 2026

(54) SYSTEM AND METHOD FOR GENERATING A BASELINE MODE OF OPERATION FROM NETWORK AND APPLICATION LOGS

(71) Applicant: BANK OF AMERICA CORPORATION, Charlotte, NC (US)

(72) Inventors: Eran Hauser, Charlotte, NC (US); Justin Miller, Fort Mill, SC (US); Vinit Shah, Indian Trail, NC (US)

(73) Assignee: BANK OF AMERICA CORPORATION, Charlotte, NC (US)

(21) Appl. No.: 18/811,998

(22) Filed: Aug. 22, 2024

(51) Int. Cl. H04L 9/40

(52) U.S. Cl. CPC H04L 63/1425; H04L 63/08

(57) ABSTRACT

Systems, computer program products, and methods are described herein for systems and methods of generating a baseline mode of operation from network and application logs. The present disclosure is configured to: identify a set of network logs from a set of networks and a set of application logs from a set of applications; scan the set of network logs and the set of application logs via an artificial intelligence engine; generate a baseline mode of operation from the set of network logs and the set of application logs via the artificial intelligence engine, where the baseline mode of operation includes a set of actions performed within the set of networks and the set of applications; monitor a received mode of operation from the set of networks and the set of applications; and evaluate the received mode of operation with respect to the baseline mode of operation.

### TECHNOLOGICAL FIELD

Example embodiments of the present disclosure relate to generating a baseline mode of operation from network and application logs.

### BACKGROUND

When monitoring a network environment, identifying potentially malicious activity has presented numerous challenges due to credentials, multiple application and network logs, and history of modes of operation within the network environment. Categorizing and identifying potentially malicious activity may increase security and efficiency within the network environment.

Applicant has identified a number of deficiencies and problems associated with generating a baseline mode of operation from network and application logs. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for systems and methods of generating a baseline mode of operation from network and application logs. In one aspect, a system for generating a baseline mode of operation from network and application logs is presented. The system including a processing device, at least one non-transitory storage device, and at least one processing device coupled to the at least one non-transitory storage device wherein the at least one processing device may be configured to: identify a set of network logs from a set of networks and a set of application logs from a set of applications; scan the set of network logs and the set of application logs via an artificial intelligence engine; generate a baseline mode of operation from the set of network logs and the set of application logs via the artificial intelligence engine, where the baseline mode of operation comprises a set of actions performed within the set of networks and the set of applications; monitor a received mode of operation from the set of networks and the set of applications; evaluate the received mode of operation in comparison to the baseline mode of operation; and determine whether the received mode of operation deviates from the baseline mode of operation.

In some embodiments, the processing device may be further configured to generate a deviation zone from the baseline mode of operation, where the deviation zone permits modes of operation deviating from the baseline mode of operation.

In some embodiments, generation of the baseline mode of operation may be based on an individual user.

In some embodiments, generation of the baseline mode of operation may be based on a group of users.

In some embodiments, the baseline mode of operation may be regenerated upon changes to the group of users.

In some embodiments, the processing device may be further configured to transmit a notification upon determination that the received mode of operation deviates from the baseline mode of operation.

In some embodiments, the baseline mode of operation may be at least partially generated based on associated authentication credentials.

In another aspect, a computer program product for generating a baseline mode of operation from network and application logs is presented. The computer program product comprising at least one non-transitory computer-readable medium having computer-readable program code portions embodied therein, the computer-readable program code portions which when executed by a processing device are configured to cause the processor to perform the following operations: identify a set of network logs from a set of networks and a set of application logs from a set of applications; scan the set of network logs and the set of application logs via an artificial intelligence engine; generate a baseline mode of operation from the set of network logs and the set of application logs via the artificial intelligence engine, where the baseline mode of operation comprises a set of actions performed within the set of networks and the set of applications; monitor a received mode of operation from the set of networks and the set of applications; evaluate the received mode of operation in comparison to the baseline mode of operation; and determine whether the received mode of operation deviates from the baseline mode of operation.

In some embodiments, the processing device may further be configured to cause the processer to generate a deviation zone from the baseline mode of operation, wherein the deviation zone permits modes of operation deviating from the baseline mode of operation.

In some embodiments, generation of the baseline mode of operation may be based on an individual user.

In some embodiments, generation of the baseline mode of operation may be based on a group of users.

In some embodiments, the baseline mode of operation may be regenerated upon changes to the group of users.

In some embodiments, the processing device may further be configured to cause the processer to transmit a notification upon determination that the received mode of operation deviates from the baseline mode of operation.

In some embodiments, the baseline mode of operation may be at least partially generated based on associated authentication credentials.

In another aspect, a computer-implemented method for generating a baseline mode of operation from network and application logs is presented. The computer-implemented method may include: identifying a set of network logs from a set of networks and a set of application logs from a set of applications; scanning the set of network logs and the set of application logs via an artificial intelligence engine; generating a baseline mode of operation from the set of network logs and the set of application logs via the artificial intelligence engine, where the baseline mode of operation comprises a set of actions performed within the set of networks and the set of applications; monitoring a received mode of operation from the set of networks and the set of applications; evaluating the received mode of operation in comparison to the baseline mode of operation; and determining whether the received mode of operation deviates from the baseline mode of operation.

In some embodiments, the method further comprises generating a deviation zone from the baseline mode of operation, wherein the deviation zone permits modes of operation deviating from the baseline mode of operation.

In some embodiments, generation of the baseline mode of operation may be based on an individual user.

In some embodiments, generation of the baseline mode of operation may be based on a group of users.

In some embodiments, the baseline mode of operation may be regenerated upon changes to the group of users.

In some embodiments, the method may further comprise transmitting a notification upon determination that the received mode of operation deviates from the baseline mode of operation.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for systems and methods of generating a baseline mode of operation from network and application logs, in accordance with an embodiment of the disclosure;

FIG. 2 illustrates an exemplary machine learning (ML) subsystem architecture, in accordance with an embodiment of the disclosure; and

FIGS. 3A-3B illustrate a process flow for systems and methods of generating a baseline mode of operation from network and application logs, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Within a network environment, credentials, frequent activity, and multiple applications and networks may be used by a plurality of entities, groups, and individuals to perform daily routines. Routines and repetitive behavior within the excessive activity may offer insights into a “normal” or a baseline mode of operation. Deviations from the baseline mode of operation may be established to determine when suspicious and/or malicious operations are detected.

Clear deviations from baseline modes of operation may indicate potentially malicious activity. For instance, a user with a baseline mode of operation indicating actions and commands within an inventory position may not be expected to command applications and networks associated with security. Changes within the modes of operation may interfere or modify applications outside of a designated role/position and may be indicative of unauthorized activity by a user or group of users. Proactively monitoring modes of operation may prevent malicious activities by said users.

Flagging, alerting, and/or spotting modes of operation that significantly deviate from established modes of operation may prevent and protect infrastructure and information within an entity. An artificial intelligence engine may learn actions and commands from network logs and application logs to generate a baseline mode of operation for a user or group of users. This baseline mode of operation may encapsulate “normal” or established operations undertaken by the user or group of users, which in turn may be utilized to protect and prevent unauthorized actions within an entity.

Accordingly, the present disclosure describes using an artificial intelligence engine to establish a baseline mode of operation from a set of logs from applications and networks for either a single user or a group of users. For instance, activities associated with a single user through network and application logs may develop a baseline mode of operation. Further, a user may access, control, and/or utilize these applications and networks within an entity. If the user or group of users access an application unrelated to their usual behavior/activity this activity may be flagged, monitored, or trigger an alert/notification. A deviation zone may further be generated; in which activities, commands, and actions outside of the baseline mode of operation may be designated as “safe” or non-concerning. For instance, an individual within an entity may have an administrative role, and the baseline mode of operation may subsequently utilize administrative applications and functions. Accessing information security applications may be designated as non-baseline modes of operation, as it deviates from established modes of operation/behavior. The deviation zone in this example may include resource allocation applications (e.g., an application not accessed regularly but ultimately may be deemed unnoteworthy).

What is more, the present disclosure provides a technical solution to a technical problem. As described herein, the technical problem includes determining when behavior within a network constitutes suspicious operations. The technical solution presented herein allows for generating a baseline mode of operation from network and application logs. In particular, generating a baseline mode of operation from network and application logs is an improvement over existing solutions to the determining when behavior within a network constitutes suspicious operations, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

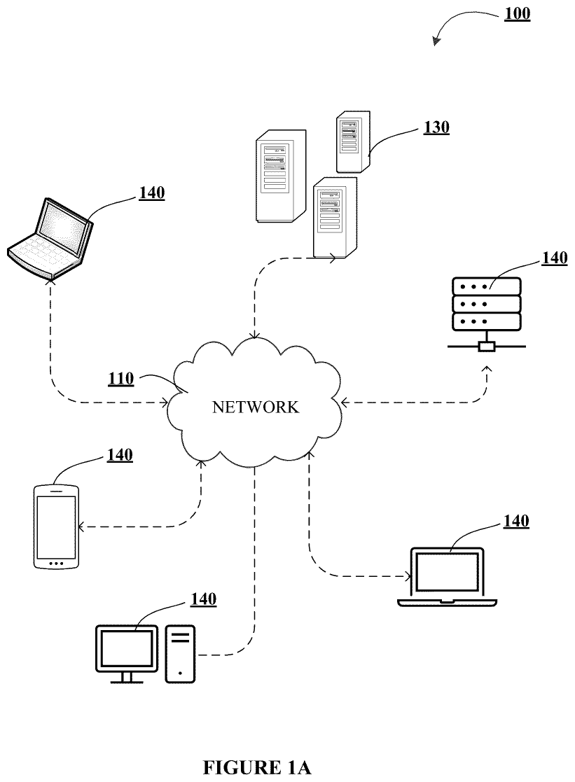

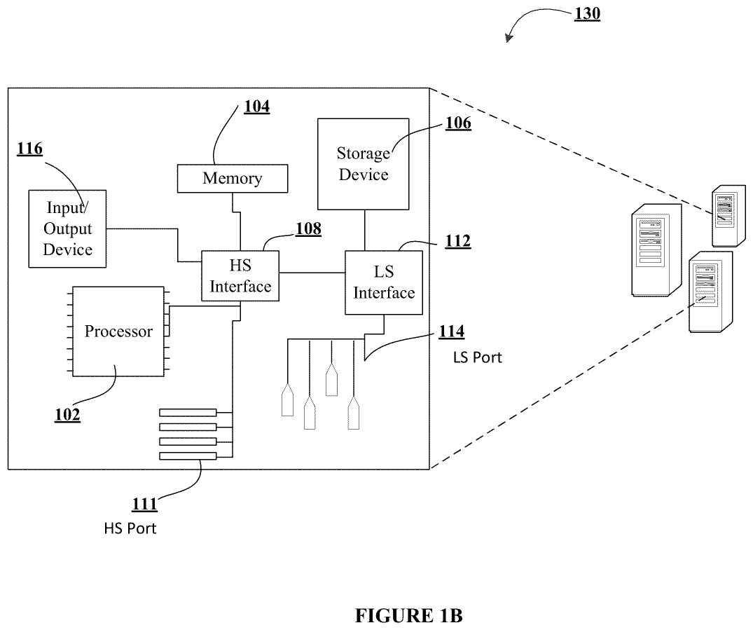

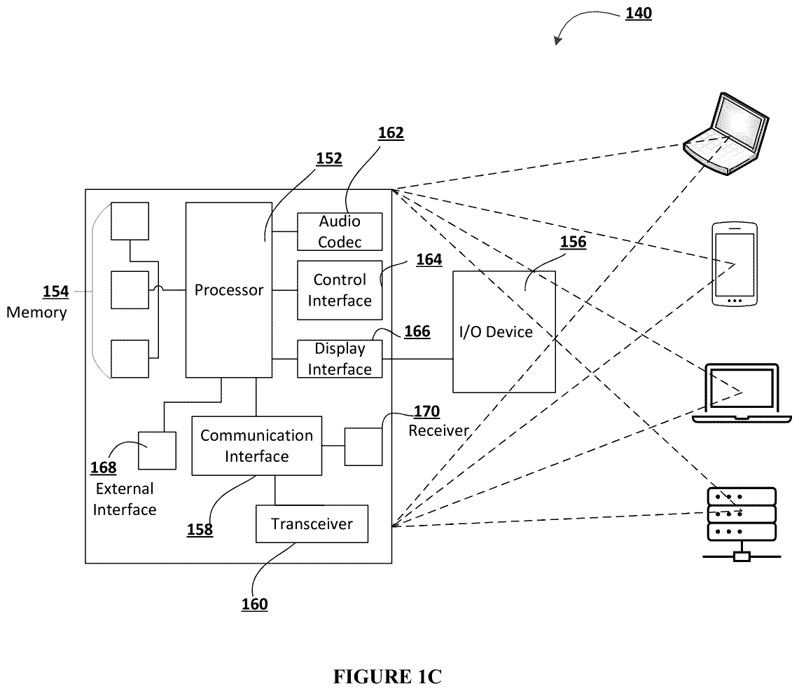

FIGS. 1A-1C illustrate technical components of an exemplary distributed computing environment for generating a baseline mode of operation from network and application logs 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

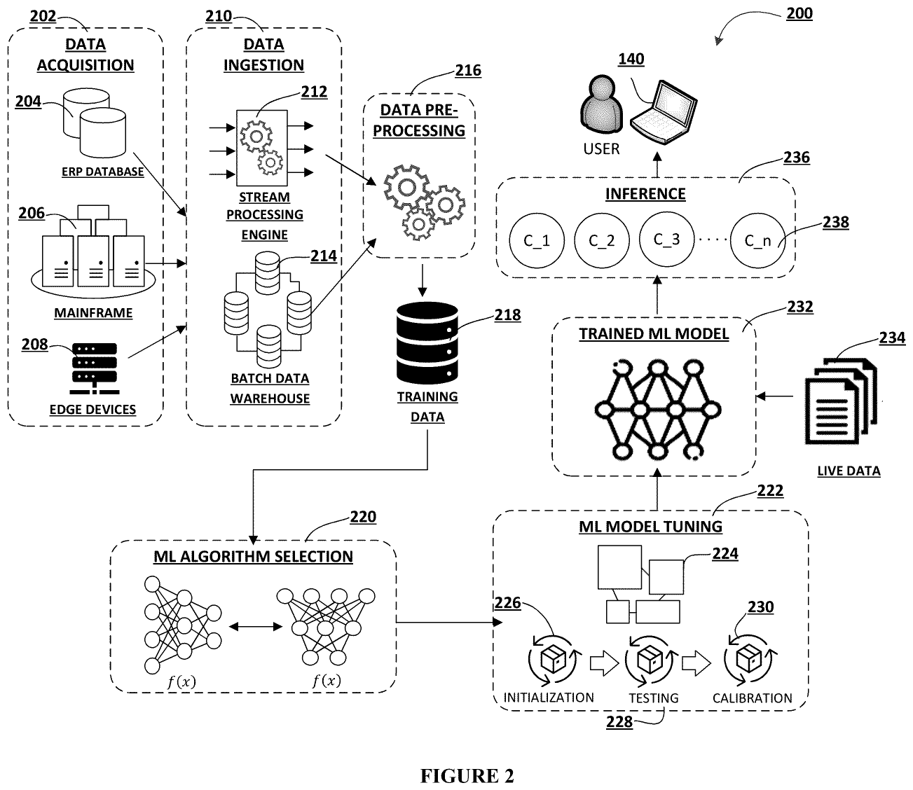

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2. . . C_n 238) live data 234 based on how similar they are to one another to solve exploratory challenges where little is known about the data, provide a description or label (e.g., C_1, C_2. . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

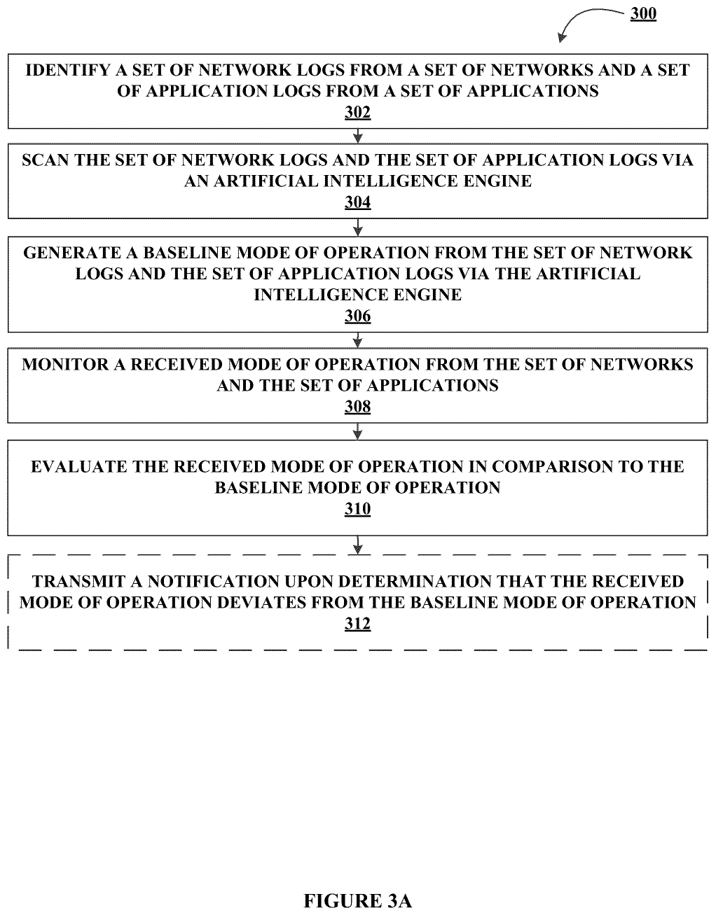

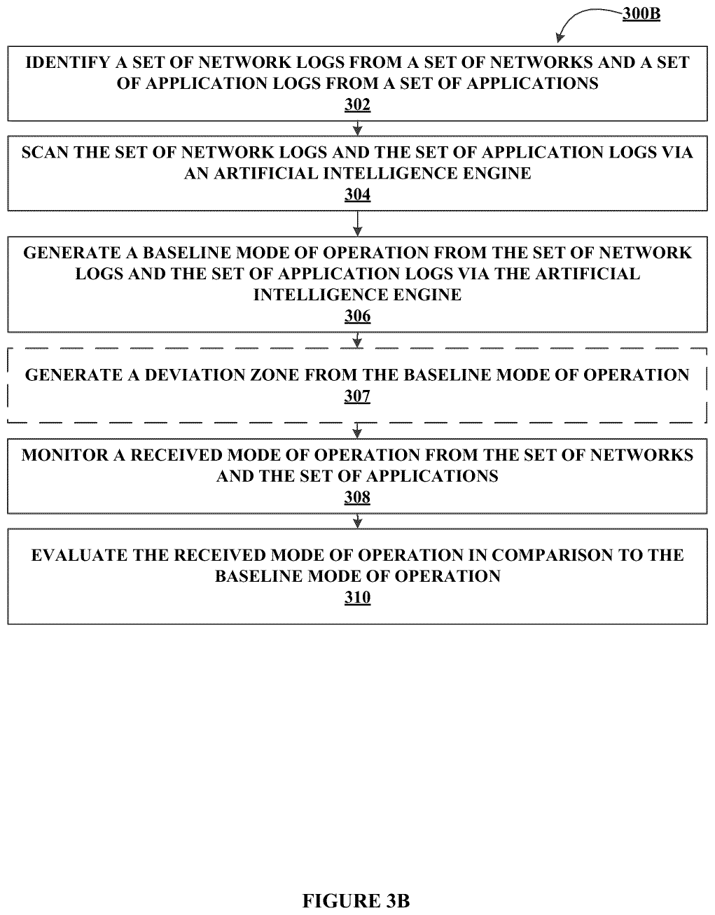

FIG. 3A illustrates a process flow for systems and methods of generating a baseline mode of operation from network and application logs. In some embodiments, a system (e.g., similar to one or more of the systems described herein with respect to FIGS. 1A-1C) may perform one or more of the steps of process flow 300. In some embodiments, a generative artificial intelligence engine (e.g., the generative AI engine shown in FIG. 2) may perform some or all the steps described in process flow 300.

As shown in Block 302, the process flow 300 may include the step of identifying a set of network logs from a set of networks and a set of application logs from a set of applications. The set of network logs may include but may not be limited to data associated with traffic and activities from the set of networks, firewall logs, router and switch logs, intrusion detection system (IDS) logs, intrusion prevention system (IPS) logs, domain name system (DNS) logs, dynamic host configuration protocol (DHCP) logs and virtual private network (VPN) logs. The set of application logs may comprise data associated with software applications, events, behavior, and performance within the set of applications. The set of application logs may include but may not be limited to event logs, error logs, access logs, interaction history logs, performance logs, and/or security logs. Logs from the set of application logs and the set of network logs may provide data regarding the health, performance, security, and/or compliance of activities and actions performed within both the set of applications and the set of networks.

Identification of the set of network logs from a set of networks may comprise organizing, refining, evaluating, and/or scanning network logs associated with a baseline mode of operation. The set of network logs may be identified from a predetermined list of networks, or a group of networks associated with operations associated with a group, team, individual, or entity using predefined identification. For instance, the set of network logs may be identified by naming conventions and/or storage locations. In another embodiment, identification of the set of network logs from a set of networks may be configured to dynamically discover the set of networks logs from the set of networks. For instance, identification of the set of networks logs from the set of networks may be identified using machine learning, context aware analysis, and pattern recognition.

As shown in Block 304, the process flow 300 may include the step of scanning the set of network logs and the set of application logs via an artificial intelligence engine. Scanning the set of network logs and the set of application logs may be conducted by the artificial intelligence engine to obtain data relevant to the baseline mode of operation, which may be described in further detail below. Data obtained from the set of network logs and the set of application logs may include but may not be limited to internet protocol (IP) addresses accessed, port usage, bandwidth consumption, time of access, geolocation data, login patterns (e.g., login frequency, time, and duration of logins specific to an application), application usage, command executions, file access patterns, error or exception logs, and/or session durations. The data obtained from scanning the set of network logs and the set of application logs may establish a pattern or “regular” mode of operation for a user. For instance, data from the set of network logs and the set of application logs may demonstrate that user A accesses applications x, y, and z, for an average time of 3 hours, provides login information twice during the same period, executes commands associated with applications x, y, and z and has generated error or exception logs on average every week. Data from the set of network logs and the set of application logs may be scanned and averaged over a predetermined length of time (e.g., a time frame may be established in which data from the set of network logs and application logs may be scanned from) to generate the baseline mode of operations.

Data from the set of network logs and application logs may be scanned and subsequently evaluated using the artificial intelligence engine. The artificial intelligence engine may be a form of machine learning as described in FIG. 2. The artificial intelligence engine may be configured to scan the set of network logs and application logs identified within the set of applications. From the gathered data, the artificial intelligence engine may then generate a baseline mode of operation as described in greater detail below.

As shown in Block 306, the process flow 300 may include the step of generating a baseline mode of operation from the set of network logs and the set of application logs via the artificial intelligence engine. A baseline mode of operation may be patterned, routine, and/or “normal” modes of operations, actions, commands, and/or executions associated with an individual, group, and/or entity. In other words, the baseline mode of operation may be expected or “usual” behavior from a user or group of users. Data scanned from the set of network logs and the set of application logs via the artificial intelligence engine may generate a baseline mode of operations for an individual, group, and/or entity to compare against a current mode of operation, as described in greater detail below.

In some embodiments, the baseline mode of operation may be generated for a group of users, predetermined group, and/or plurality of individual users. The predetermined group may include a plurality of individuals, users, and/or team. For instance, the predetermined group may be a team assigned to conduct administrative functions within an entity (e.g., filing, organizing, and directing communications within an entity). The baseline mode of operation generated for the team tasked with administrative functions may subsequently utilize programs, applications, commands, and functions associated with said administrative functions (e.g., using an email program for communications, a spreadsheet program for organization). Deviation from the baseline mode of operation may include accessing, operating, executing, using, and/or performing actions inconsistent with the baseline mode of operation. For instance, the baseline mode of operation for an administrative functions team may have parameters indicating what the baseline mode of operation may entail (e.g., actions, commands, and/or routines previously performed that may indicate baseline or “normal” modes of operation). Deviation from the baseline mode of operation may be monitored, flagged, and/or trigger further commands as described in greater detail below.

As shown in Block 308, the process flow 300 may include the step of monitoring a received mode of operation from the set of networks and the set of applications. Monitoring the received mode of operation from the set of networks and the set of applications may comprise recording, watching, observing, and/or receiving input to a current mode of operation. The received mode of operation may be commands, actions, inputs, application activities, network activities, operations conducted, and actions previously undocumented within the set of network logs and the set of application logs. In other words, the received mode of operation may be “current” activities performed that can be compared against the generated baseline mode of operation to determine whether activities being performed conform within the baseline mode of operation, as described in greater detail below.

In some embodiments, the received mode of operation may be from a single individual user. In other words, the baseline mode of operation may be established for an individual user which may determine actions, commands, and activities that may constitute “normal” or routine operations for the individual user. For instance, a user within an entity may be assigned an administrative position with a corresponding respective baseline mode of operation reflecting such. The current mode of operation for the individual user may be operations, commands, and/or actions performed by the user which may then be compared against the baseline mode of operation. For instance, opening a spreadsheet application may conform to the baseline mode of operation, while accessing network security applications may be outside the baseline mode of operations. The evaluation of whether the received mode of operation deviates from the baseline mode of operation may trigger notifications, warnings, and/or messages as described in greater detail below.

In some embodiments, the received mode of operation may be from an individual user, a group of users, a predetermined team, and/or plurality of individual users. For instance, multiple individual users within an entity may be assigned administrative positions and the team overall has established a baseline mode of operations. The received mode of operation of the team may be monitored to determine whether the current mode of operations conducted by the group of users conforms to the baseline mode of operations. The evaluation of whether the received mode of operation from the group of users deviates from the baseline mode of operation may trigger notifications, warnings, and/or messages as described in greater detail below.

In some embodiments, the baseline mode of operation may be regenerated upon changes to the group of users. For instance, if an individual user is added to the group of users, the received mode of operation and baseline mode of operations for the group of users may be altered. The addition of the individual user may trigger regeneration of the baseline mode of operation with the set of network logs and the set of application logs associated with the additional individual user used to generate the baseline mode of operation. The baseline mode of operation may be regenerated upon removal of individual users from the group of users. For instance, if an administrative team is reduced by at least one user, the baseline mode of operation may be regenerated to reflect the baseline mode of operations for the reduced group of users/team.

In some embodiments, the baseline mode of operation may be at least partially generated based on associated authentication credentials. The associated authentication credentials may be authentication credentials from a user and/or group of users from which the baseline mode of operation may be generated from. The associated authentication credentials may indicate the user or group of users may deviate from the baseline mode of operation to a greater degree and may therefore access and command applications outside of the baseline mode of operation with a greater frequency. For instance, an overall manager of an entity may have authentication credentials enabling access to all applications and networks within the entity. The associated authentication credentials of the overall manager may change the baseline mode of operation, and reduce notifications triggered from operating outside of an established mode of operation.

As shown in Block 310, in some embodiments, the process flow 300 may include the step of evaluating the received mode of operation with respect to the baseline mode of operation. Evaluation of the received mode of operation may comprise determining whether the received mode of operation is within the baseline mode of operation. For instance, if a baseline mode of operation is associated with administrative networks and applications, receiving modes of operation associated with security and access may be flagged as outside of the baseline mode of operation. Determining that the received mode of operation deviates from the baseline mode of operation may trigger transmission of a notification to a predetermined source. For instance, a predetermined team dealing with information security may receive the notification indicating that a user deviated from a baseline mode of operation. Preventative actions may be implemented/triggered to minimize unauthorized commands and actions by said user.

As shown in Block 312, in some embodiments, the process flow 300 may include the step of transmitting a notification upon determination that the received mode of operation deviates from the baseline mode of operation. If the received mode of operation deviates from the baseline mode of operations a notification, message, or warning may be transmitted to a predetermined source. The notification may comprise information associated with the user or group of users who deviated from the baseline mode of operation and how the deviation was produced. For instance, if a user associated with administrative policies deviates into accessing and changing cyber security applications, a notification may be transmitted to users or a group of users associated with cyber security applications.

FIG. 3B illustrates an extended process flow for systems and methods of generating a baseline mode of operation from network and application logs demonstrated in FIG. 3A. In some embodiments, a system (e.g., similar to one or more of the systems described herein with respect to FIGS. 1A-1C) may perform one or more of the steps of process flow 300B. In some embodiments, a generative artificial intelligence engine (e.g., the generative AI engine shown in FIG. 2) may perform some or all the steps described in process flow 300 and 300B.

As shown in Block 307, in some embodiments, the process flow 300B may include the step of generating a deviation zone from the baseline mode of operation. The deviation zone may permit modes of operation deviating from the baseline mode of operation. Applications and network functions may be outside of the baseline mode of operation for users but may be exempted from the status of deviating from the baseline mode of operations within the deviation zone. For instance, a user with an administrative position may not access applications associated with resource exchanges within an entity on a “normal” basis. However, there may be commands and actions performed by the user or group of users within the applications associated with resource exchanges that, while not routine, may be exempted as deviating from the baseline mode of operation. In other words, the deviation zone may be an exception from the baseline mode of operation that may not be designated as noteworthy. The deviation zone may be altered depending on the user or group of users.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating a baseline mode of operation from network and application logs, the system comprising:
a processing device;
at least one non-transitory storage device; and
at least one processing device coupled to the at least one non-transitory storage device, wherein the at least one processing device is configured to:
identify a set of network logs from a set of networks and a set of application logs from a set of applications;
scan the set of network logs and the set of application logs via an artificial intelligence engine;
generate a baseline mode of operation from the set of network logs and the set of application logs via the artificial intelligence engine;
wherein the baseline mode of operation comprises a set of actions performed within the set of networks and the set of applications;
monitor a received mode of operation from the set of networks and the set of applications; and
evaluate the received mode of operation with respect to the baseline mode of operation.

2. The system of claim 1, wherein the processing device is further configured to generate a deviation zone from the baseline mode of operation, wherein the deviation zone permits modes of operation deviating from the baseline mode of operation.

3. The system of claim 2, wherein generation of the baseline mode of operation is based on an individual user.

4. The system of claim 2, wherein generation of the baseline mode of operation is based on a group of users.

5. The system of claim 4, wherein the baseline mode of operation is regenerated upon changes to the group of users.

6. The system of claim 2, wherein the processing device is further configured to transmit a notification upon determination that the received mode of operation deviates from the baseline mode of operation.

7. The system of claim 1, wherein the baseline mode of operation is at least partially generated based on associated authentication credentials.

8. A computer program product for generating a baseline mode of operation from network and application logs, the computer program product comprising at least one non-transitory computer-readable medium having computer-readable program code portions embodied therein, the computer-readable program code portions which when executed by a processing device are configured to cause a processor to perform the following operations:
identify a set of network logs from a set of networks and a set of application logs from a set of applications;
scan the set of network logs and the set of application logs via an artificial intelligence engine;
generate a baseline mode of operation from the set of network logs and the set of application logs via the artificial intelligence engine,
wherein the baseline mode of operation comprises a set of actions performed within the set of networks and the set of applications;
monitor a received mode of operation from the set of networks and the set of applications;
evaluate the received mode of operation in comparison to the baseline mode of operation; and
determine whether the received mode of operation deviates from the baseline mode of operation.

9. The computer program product of claim 8, wherein the processing device is further configured to cause the processer to generate a deviation zone from the baseline mode of operation, wherein the deviation zone permits modes of operation deviating from the baseline mode of operation.

10. The computer program product of claim 9, wherein generation of the baseline mode of operation is based on an individual user.

11. The computer program product of claim 9, wherein generation of the baseline mode of operation is based on a group of users.

12. The computer program product of claim 11, wherein the baseline mode of operation is regenerated upon changes to the group of users.

13. The computer program product of claim 9, wherein the processing device is further configured to cause the processer to transmit a notification upon determination that the received mode of operation deviates from the baseline mode of operation.

14. The computer program product of claim 8, wherein the baseline mode of operation is at least partially generated based on associated authentication credentials.

15. A computer-implemented method for generating a baseline mode of operation from network and application logs the computer-implemented method comprising:
identifying a set of network logs from a set of networks and a set of application logs from a set of applications;
scanning the set of network logs and the set of application logs via an artificial intelligence engine;
generating a baseline mode of operation from the set of network logs and the set of application logs via the artificial intelligence engine,
wherein the baseline mode of operation comprises a set of actions performed within the set of networks and the set of applications;
monitoring a received mode of operation from the set of networks and the set of applications;
evaluating the received mode of operation in comparison to the baseline mode of operation; and
determining whether the received mode of operation deviates from the baseline mode of operation.

16. The computer-implemented method of claim 15, wherein the method further comprises generating a deviation zone from the baseline mode of operation, wherein the deviation zone permits modes of operation deviating from the baseline mode of operation.

17. The computer-implemented method of claim 16, wherein generation of the baseline mode of operation is based on an individual user.

18. The computer-implemented method of claim 16, wherein generation of the baseline mode of operation is based on a group of users.

19. The computer-implemented method of claim 18, wherein the baseline mode of operation is regenerated upon changes to the group of users.

20. The computer-implemented method of claim 16, wherein the method further comprises transmitting a notification upon determination that the received mode of operation deviates from the baseline mode of operation.
